(19) United States
(12) Patent Application Publication
(10) Pub. No.: US 2014/0253087 A1
(43) Pub. Date: Sep. 11, 2014

(54) FIXED VOLTAGE GENERATING CIRCUIT

(71) Applicant: RICHWAVE TECHNOLOGY CORP., Taipei City (TW)

(72) Inventor: Chih-Sheng Chen, Taipei City (TW)

(73) Assignee: RichWave Technology Corp., Taipei City (TW)

(21) Appl. No.: 13/865,205

(22) Filed: Apr. 18, 2013

(30) Foreign Application Priority Data
Mar. 5, 2013 (TW) 102107705

(51) Int. Cl. G05F 3/16

(52) U.S. Cl. CPC G05F 3/16
USPC 323/313

(57) ABSTRACT

A fixed voltage generating circuit includes a current mirror, a differential pair, and a resistor coupled to the current mirror. A node of the resistor is coupled to a voltage source. The differential pair includes two resistors coupled to the voltage source for enabling the differential pair to output a fixed voltage.

### BACKGROUND OF THE INVENTION

1. Field of the Invention

The invention is related to a fixed voltage generating circuit, and more particularly, to a fixed voltage generating circuit fabricated using a GaAs (GALLIUM ARSENIDE) process.

2. Description of the Prior Art

An RF power amplifier fabricated using a GaAs process has good performance and high efficiency, specifically, the RF power amplifier is less prone to signal distortion, has a lower noise to signal ratio, lower power consumption, higher gain, and smaller size. Thus the RF power amplifier gains advantages of shrinking sizes, increasing efficiency, and lowering power consumption of electronic components, and is suitable for use in mobile phones and all ranges of communication devices.

In order that the RF power amplifier fabricated using a GaAs process can function normally under a wide input voltage range, a fixed voltage generated by a fixed voltage generating circuit is provided for operations of the RF power amplifier to ensure the RF power amplifier can function normally.

However the fixed voltage generating circuit is usually fabricated using a CMOS (complementary metal-oxide-semiconductor) process, which includes PMOS (P-type metal-oxide-semiconductor) that is not suitable in a GaAs process. Thus the fixed voltage generating circuit cannot be integrated and fabricated in the same GaAs process when fabricating the RF power amplifier. Instead, an additional CMOS process is needed for fabricating the fixed voltage generating circuit to provide the fixed voltage to the RF power amplifier, thereby increasing sizes and lowering integration of related components.

### SUMMARY OF THE INVENTION

An embodiment of the present invention discloses a fixed voltage generating circuit. The fixed voltage generating circuit comprises a first resistor, a first transistor, a second transistor, a third transistor, a fourth transistor, a second resistor, and a third resistor. The first resistor has a first end and a second end, the second end being coupled to a voltage source. The first transistor has a control end coupled to the first end of the first resistor, a first end coupled to a ground node, and a second end coupled to the control end of the first transistor. The second transistor has a control end coupled to the first end of the first resistor and a first end coupled to the ground node. The third transistor has a control end for receiving a first differential voltage and a first end coupled to a second end of the second transistor. The fourth transistor has a control end for receiving a second differential voltage and a first end coupled to the second end of the second transistor. The second resistor has a first end coupled to a second end of the third transistor and a second end coupled to the voltage source. The third resistor has a first end coupled to a second end of the fourth transistor and a second end coupled to the voltage source. Resistance of the second resistor and resistance of the third resistor are substantially equal.

Another embodiment of the present invention discloses a fixed voltage generating circuit. The A fixed voltage generating circuit comprises a first resistor, a first transistor, a second transistor, a third transistor, a fourth transistor, a second resistor, and a third resistor. The first transistor has a control end coupled to a first end of the first resistor, a first end coupled to a ground node, and a second end coupled to the control end of the first transistor. The second transistor has a control end coupled to the first end of the first resistor and a first end coupled to the ground node. The third transistor has a control end for receiving a first differential voltage and a first end coupled to a second end of the second transistor. The fourth transistor has a control end for receiving a second differential voltage and a first end coupled to the second end of the second transistor. The second resistor has a first end coupled to a second end of the third transistor, and a second end coupled to a voltage source. The third resistor has a first end coupled to a second end of the fourth transistor, and a second end coupled to the voltage source. Equivalent resistance of the second resistor and the third resistor is substantially equal to resistance of the first resistor and resistance of the second resistor and resistance of the third resistor are substantially equal.

Another embodiment of the present invention discloses a fixed voltage generating circuit. The fixed voltage generating circuit comprises a first resistor, a first transistor, a second transistor, a third transistor, a fourth transistor, a second resistor, a third resistor, and a fourth resistor. The first transistor has a control end coupled to a first end of the first resistor, a first end coupled to a ground node, and a second end coupled to the control end of the first transistor. The second transistor has a control end coupled to the first end of the first resistor and a first end coupled to the ground node. The third transistor has a control end for receiving a first differential voltage and a first end coupled to a second end of the second transistor. The fourth transistor has a control end for receiving a second differential voltage and a first end coupled to the second end of the second transistor. The second resistor has a first end coupled to a second end of the third transistor. The third resistor has a first end coupled to a second end of the fourth transistor. The fourth resistor has a first end coupled to a second end of the second resistor and a second end of the third resistor, and a second end coupled to a voltage source. Equivalent resistance of the second resistor, the third resistor, and the fourth resistor is substantially equal to resistance of the first resistor, and resistance of the second resistor and resistance of the third resistor are substantially equal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic illustrating fixed voltage generating circuit according to an embodiment of the present invention.

FIG. 2 is a schematic illustrating fixed voltage generating circuit according to another embodiment of the present invention.

FIG. 3 is a schematic illustrating fixed voltage generating circuit according to another embodiment of the present invention.

FIG. 4 is a schematic illustrating fixed voltage generating circuit according to an embodiment of the present invention.

### DETAILED DESCRIPTION

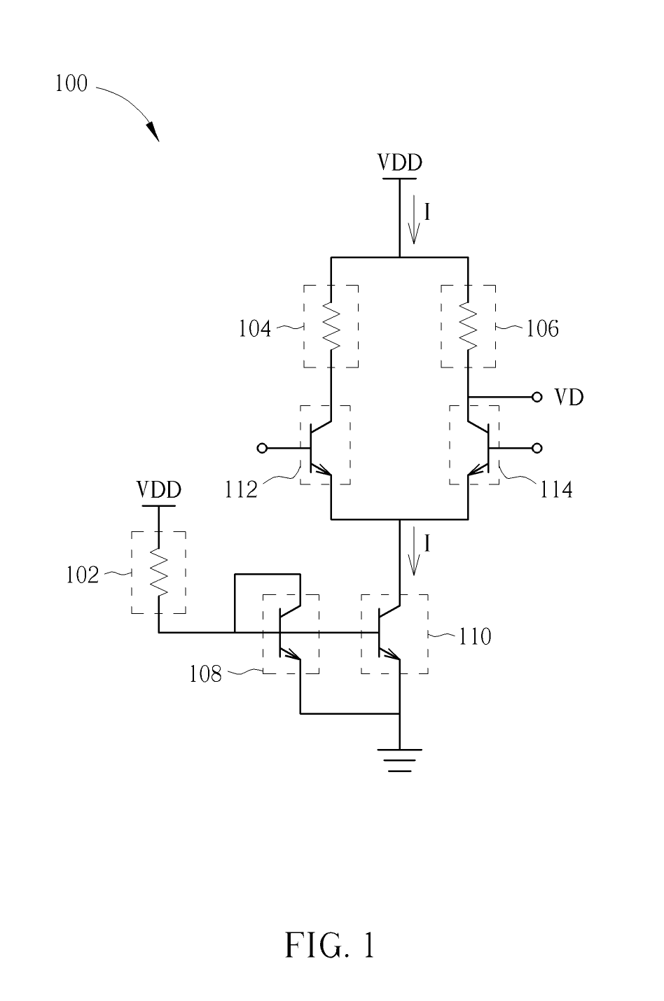

Please refer to FIG. 1 which is a schematic illustrating a fixed voltage generating circuit 100 according to an embodiment of the present invention. The fixed voltage generating circuit 100 may include a first resistor 102, a second resistor 104, a third resistor 106, a first transistor 108, a second transistor 110, a third transistor 112, and a fourth transistor 114. The first resistor 102 has a first end and a second end, the second end being coupled to a voltage source VDD. The first transistor 108 has a control end coupled to the first end of the first resistor 102, a first end coupled to a ground node, and a second end coupled to the control end of the first transistor 108. The second transistor 110 has a control end coupled to the first end of the first resistor 102 and a first end coupled to the ground node. The third transistor 112 has a control end for receiving a first differential voltage and a first end coupled to a second end of the second transistor 110. The fourth transistor 114 has a control end for receiving a second differential voltage and a first end coupled to the second end of the second transistor 110. The second resistor 104 has a first end coupled to a second end of the third transistor 112 and a second end coupled to the voltage source VDD. The third resistor 106 has a first end coupled to a second end of the fourth transistor 114 and a second end coupled to the voltage source VDD. A resistance ratio of the first resistor 102, the second resistor 104, and the third resistor 106 is substantially equal to 1:2:2, and resistance of the second resistor 104 and resistance of the third resistor 106 are substantially equal.

In FIG. 1, a bias voltage is generated via the first resistor 102 at the control end of the first transistor 108 according to the voltage source VDD. The first transistor 108 and the second transistor 110 form a current mirror and a bias current I is generated at the second end of the second transistor 110 according to the bias voltage at the control end of the first transistor 108, as in formula (1) (where a voltage difference between the control end of the first transistor 108 and the ground node is small and negligible). The bias current I also flows through a differential pair formed by the third transistor 112, the fourth transistor 114, the second resistor 104, and the third resistor 106. A current flowing through the right side of the differential pair, including the fourth transistor 114 and the third resistor 106, is half the bias current I because components in the right side and components in the left side of the differential pair are substantially symmetrical. The differential pair is coupled to the voltage source VDD and thus a voltage VD is generated at the second end of the fourth transistor 114, as in formula (2).

In formula (1) and formula (3), R1 is resistance of the first resistor 102. In formula (2) and formula (4), R3 is resistance of the third resistor 106, and Re1 is equivalent resistance of the second resistor 104 and the third resistor 106, which is equal to parallel resistance of the second resistor 104 and the third resistor 106 because the right side and the left side of the differential pair are paralleled structure and the resistance of the second resistor 104 and the resistance of the third resistor 106 are substantially equal. Thus

$$Re 1 = \frac{R 3}{2} .$$

$$\begin{matrix}I = \frac{VDD}{R 1} & Formula ( 1 ) \\ \begin{matrix}VD = VDD - \frac{I}{2} \times R 3 \\ = VDD - I \times Re 1 \\ = VDD - \frac{VDD}{R 1} \times Re 1\end{matrix} & Formula ( 2 )\end{matrix}$$

According to formula (1), when the voltage source VDD varies, the bias current I flowing through the differential pair changes accordingly. Assuming the voltage source VDD varies by a voltage variation dVDD which causes the bias current I to change by a current variation dI, as in formula (3). At this time, the voltage VD at the second end of the fourth transistor 114 changes by a voltage deviation dVD, as in formula (4). In formula (4), if R1=Re1, that is, the resistance of the first resistor 102 is substantially equal to the equivalent resistance Re1 of the second resistor 104 and the third resistor 106, the change of the voltage deviation dVD of the voltage VD is substantially zero, namely, the voltage VD is fixed and does not change with the voltage variation dVDD of the voltage source VDD.

$$\begin{matrix}d I = \frac{d VDD}{R 1} & Formula ( 3 ) \\ \begin{matrix}d VD = d VDD - \frac{d I}{2} \times R 3 \\ = d VDD - d I \times Re 1 \\ = d VDD - \frac{d VDD}{R 1} \times Re 1\end{matrix} & Formula ( 4 )\end{matrix}$$

As illustrated above in FIG. 1, a fixed voltage VD which does not change with the voltage source VDD is generated so that the fixed voltage generating circuit 100 may work under a wide range of input voltages. In the prior art, the second resistor 104 and the third resistor 106 are replaced with PMOSs in CMOS process which are not suitable for a GaAs process, thus adapting circuit structure used in CMOS process for a GaAa process is not practical. However by adjusting a resistance ratio of multiple resistors and implementing a circuit structure of connecting resistors to the voltage source VDD as described in the embodiment of the present invention, the fixed voltage VD can be generated in a GaAs process without using an additional CMOS process to provide a fixed voltage so as to increase sizes and lowering integration of related components.

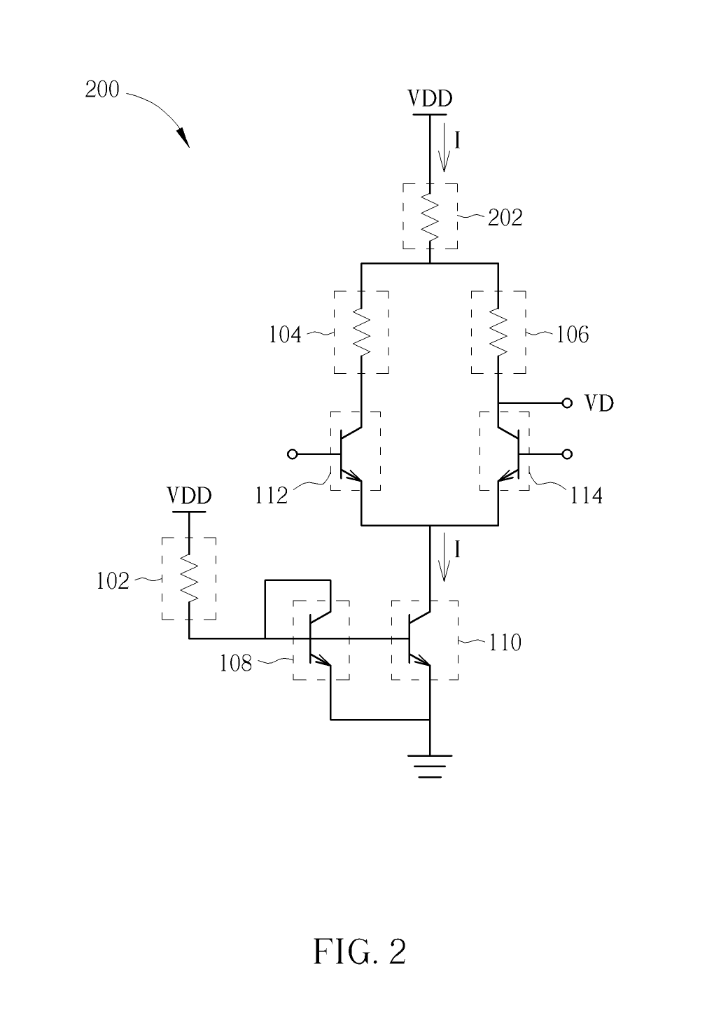

Please refer to FIG. 2 which is a schematic illustrating a fixed voltage generating circuit 200 according to another embodiment of the present invention. The fixed voltage generating circuit 200 may include all components the fixed voltage generating circuit 100 and may further include a fourth resistor 202. The second resistor 104 and the third resistor 106 of FIG. 2 are not coupled directly to the voltage source VDD but are coupled to the voltage source VDD via the fourth resistor 202. The fourth resistor 202 has a first end coupled to the second end of the second resistor 104 and the second end of the third resistor 106, and a second end coupled to the voltage source VDD. Equivalent resistance of the second resistor 104, the third resistor 106, and the fourth resistor 202 is substantially equal to the resistance of the first resistor 102. The resistance of the second resistor 104 and the resistance of the third resistor 106 are substantially equal.

The same principle of formula (1) and formula (3) may be applied in FIG. 2. The bias current I flows through the fourth resistor 202 and the differential pair formed by the third transistor 112, the fourth transistor 114, the second resistor 104, and the third resistor 106. The current flowing through the right side of the differential pair, including the fourth transistor 114 and the third resistor 106, is half the bias current I because the components in the right side and the components in the left side of the differential pair are substantially symmetrical. The fourth resistor 202 is coupled to the voltage source VDD thus a voltage VD is generated at the second end of the fourth transistor 114, as in formula (5).

In formula (5) and formula (6), R3 is the resistance of the third resistor 106, R4 is resistance of the fourth resistor 202, and Re2 is equivalent resistance of the second resistor 104, the third resistor 106, and the fourth resistor 202. The equivalent resistance of the second resistor 104 and the third resistor 106 is equal to the parallel resistance of the second resistor 104 and the third resistor 106. The equivalent resistance of the second resistor 104, the third resistor 106, and the fourth resistor 202 is equal to the equivalent resistance of the second resistor 104 and the third resistor 106 plus the resistance of the fourth resistor 202. The resistance of the second resistor 104 and the resistance of the third resistor 106 are substantially equal. Thus

$$Re 2 = \frac{R 3}{2} + R 4.$$

$$\begin{matrix}VD = VDD - I \times R 4 - \frac{I}{2} \times R 3 \\ = VDD - I \times Re 2 \\ = VDD - \frac{VDD}{R 1} \times Re 2\end{matrix} \qquad Formula ( 5 )$$

According to formula (1), when the voltage source VDD varies, the bias current I changes accordingly. The bias current I changes by a current variation dI, as in formula (3) and the voltage VD at the second end of the fourth transistor 114 changes by a voltage deviation dVD, as in formula (6). In formula (6), if R1=Re2, that is, the resistance of the first resistor 102 is substantially equal to the equivalent resistance Re2 of the second resistor 104, the third resistor 106, and the fourth resistor 202, the change of the voltage deviation dVD of the voltage VD is substantially zero, namely, the voltage VD is fixed and does not change with the voltage variation dVDD of the voltage source VDD.

$$\begin{matrix}d VD = d VDD - d I \times R 4 - \frac{d I}{2} \times R 3 \\ = d VDD - d I \times Re 2 \\ = d VDD - \frac{d VDD}{R 1} \times Re 2\end{matrix} \qquad Formula ( 6 )$$

As illustrated above in FIG. 2, the fixed voltage VD which does not change with the voltage source VDD is generated in a GaAs process so that the fixed voltage generating circuit 200 may work under a wide range of input voltages without using additional CMOS process to provide a fixed voltage.

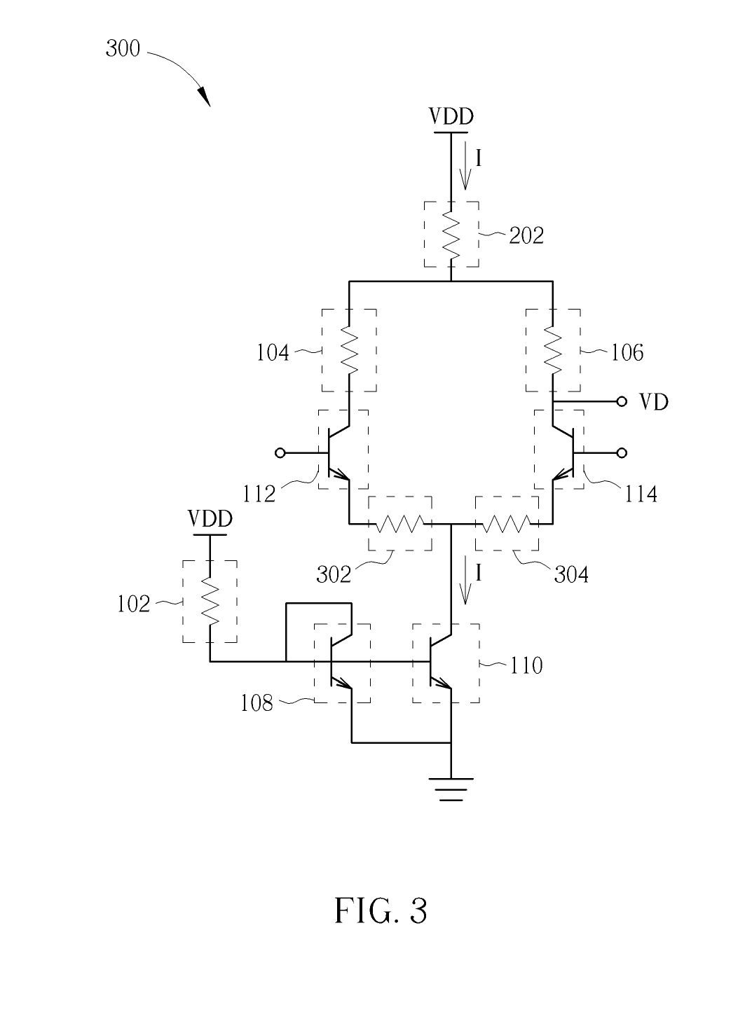

Please refer to FIG. 3 which is a schematic illustrating fixed voltage generating circuit 300 according to another embodiment of the present invention. The fixed voltage generating circuit 300 may include all components of the fixed voltage generating circuit 200 and may further include a fifth resistor 302 coupled between the first end of the third transistor 112 and the second end of the second transistor 110, and a sixth resistor 304 coupled between the first end of the fourth transistor 114 and the second end of the second transistor 110.

In FIG. 3, the bias current I flows through the fourth resistor 202, the fifth resistor 302, the sixth resistor 304, and the differential pair. The current flowing through the right side of the differential pair is half the bias current I. The same principle of formula (1), (3), (5), (6) may be applied in FIG. 3. As long as R1=Re2, that is, the resistance of the first resistor 102 is substantially equal to the equivalent resistance Re2 of the second resistor 104, the third resistor 106, and the fourth resistor 202, the change of the voltage deviation dVD of the voltage VD is substantially zero, namely, the voltage VD is fixed and does not change with the voltage variation dVDD of the voltage source VDD.

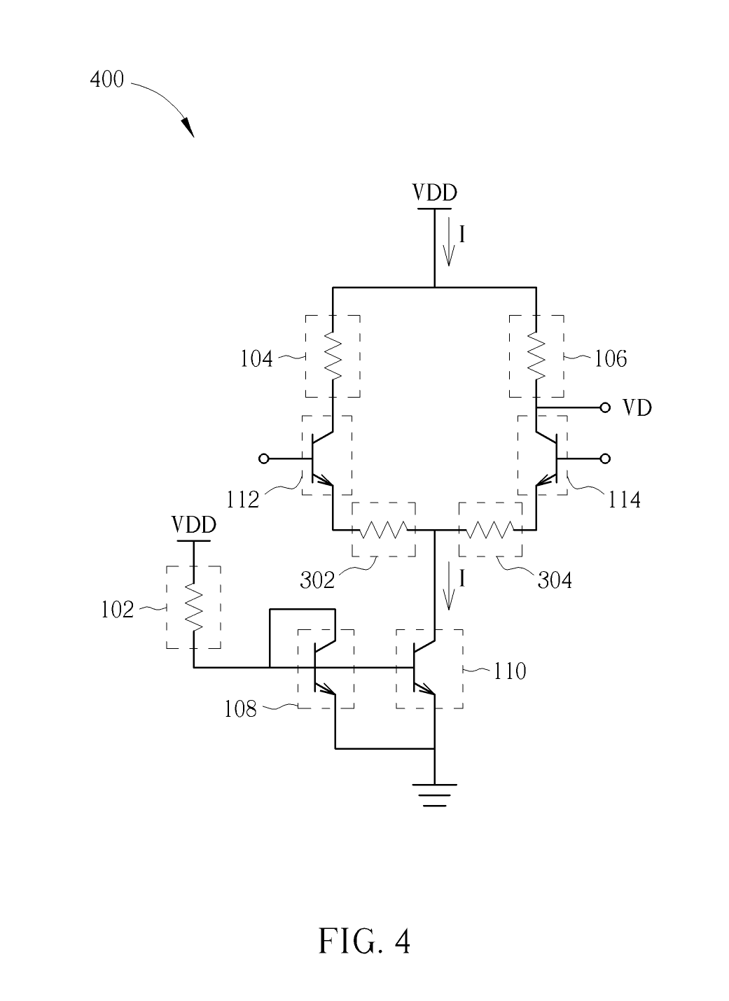

Please refer to FIG. 4 which is a schematic illustrating fixed voltage generating circuit 400 according to an embodiment of the present invention. The fixed voltage generating circuit 400 may include all components of the fixed voltage generating circuit 100 and may further include a fifth resistor 302 coupled between the first end of the third transistor 112 and the second end of the second transistor 110, and a sixth resistor 304 coupled between the first end of the fourth transistor 114 and the second end of the second transistor 110.

In FIG. 4, the bias current I flows through the fifth resistor 302, the sixth resistor 304, and the differential pair. The current flowing through the right side of the differential pair is half the bias current I. The same principles of formula (1) to (4) may be applied in FIG. 4. As long as R1=Re1, that is, the resistance of the first resistor 102 is substantially equal to the equivalent resistance Re1 of the second resistor 104 and the third resistor, the change of the voltage deviation dVD of the voltage VD is substantially zero, namely, the voltage VD is fixed and does not change with the voltage variation dVDD of the voltage source VDD.

In summary, by adjusting a resistance ratio of multiple resistors and implementing a circuit structure of connecting resistors to the voltage source VDD as described in the embodiment of the present invention, the fixed voltage VD can be generated in a GaAs process without using an additional CMOS process to provide a fixed voltage so as to increase sizes and lowering integration of related components in fabrication.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A fixed voltage generating circuit comprising:
a first resistor having a first end and a second end, the second end being coupled to a voltage source;
a first transistor having a control end coupled to the first end of the first resistor, a first end coupled to a ground node, and a second end coupled to the control end of the first transistor;
a second transistor having a control end coupled to the first end of the first resistor, and a first end coupled to the ground node;
a third transistor having a control end for receiving a first differential voltage, and a first end coupled to a second end of the second transistor;
a fourth transistor having a control end for receiving a second differential voltage, and a first end coupled to the second end of the second transistor;
a second resistor having a first end coupled to a second end of the third transistor, and a second end coupled to the voltage source; and
a third resistor having a first end coupled to a second end of the fourth transistor, and a second end coupled to the voltage source;
wherein resistance of the second resistor and resistance of the third resistor are substantially equal.

2. The fixed voltage generating circuit of claim 1, wherein equivalent resistance of the second resistor and the third resistor is substantially equal to resistance of the first resistor.

3. The fixed voltage generating circuit of claim 1 further comprising a fourth resistor having a first end coupled to the second end of the second resistor and the second end of the third resistor, and a second end coupled to the voltage source.

4. The fixed voltage generating circuit of claim 3, wherein equivalent resistance of the second resistor, the third resistor, and the fourth resistor is substantially equal to resistance of the first resistor.

5. The fixed voltage generating circuit of claim 1 further comprising:
a fifth resistor coupled between the first end of the third transistor and the second end of the second transistor; and
a sixth resistor coupled between the first end of the fourth transistor and the second end of the second transistor.

6. A fixed voltage generating circuit comprising:
a first resistor;
a first transistor having a control end coupled to a first end of the first resistor, a first end coupled to a ground node, and a second end coupled to the control end of the first transistor;
a second transistor having a control end coupled to the first end of the first resistor, and a first end coupled to the ground node;
a third transistor having a control end for receiving a first differential voltage, and a first end coupled to a second end of the second transistor;
a fourth transistor having a control end for receiving a second differential voltage, and a first end coupled to the second end of the second transistor;
a second resistor having a first end coupled to a second end of the third transistor, and a second end coupled to a voltage source; and
a third resistor having a first end coupled to a second end of the fourth transistor, and a second end coupled to the voltage source;
wherein equivalent resistance of the second resistor and the third resistor is substantially equal to resistance of the first resistor, and resistance of the second resistor and resistance of the third resistor are substantially equal.

7. The fixed voltage generating circuit of claim 6 further comprising:
a fifth resistor coupled between the first end of the third transistor and the second end of the second transistor; and
a sixth resistor coupled between the first end of the fourth transistor and the second end of the second transistor.

8. A fixed voltage generating circuit comprising:
a first resistor;
a first transistor having a control end coupled to a first end of the first resistor, a first end coupled to a ground node, and a second end coupled to the control end of the first transistor;
a second transistor having a control end coupled to the first end of the first resistor, and a first end coupled to the ground node;
a third transistor having a control end for receiving a first differential voltage, and a first end coupled to a second end of the second transistor;
a fourth transistor having a control end for receiving a second differential voltage, and a first end coupled to the second end of the second transistor;
a second resistor having a first end coupled to a second end of the third transistor;
a third resistor having a first end coupled to a second end of the fourth transistor; and
a fourth resistor having a first end coupled to a second end of the second resistor and a second end of the third resistor, and a second end coupled to a voltage source;
wherein equivalent resistance of the second resistor, the third resistor, and the fourth resistor is substantially equal to resistance of the first resistor, and resistance of the second resistor and resistance of the third resistor are substantially equal.

9. The fixed voltage generating circuit of claim 8 further comprising:
a fifth resistor coupled between the first end of the third transistor and the second end of the second transistor; and
a sixth resistor coupled between the first end of the fourth transistor and the second end of the second transistor.
